(19) United States
(12) Patent Application Publication
(10) Pub. No.: US 2004/0263405 A1
(43) Pub. Date: Dec. 30, 2004

(54) Method for forming automotive antenna

(75) Inventors: Hideo Kogure, Kanagawa (JP); Yu Akaki, Tokyo (JP); Shigeru Nakamura, Aichi (JP)

Correspondence Address: FOLEY AND LARDNER, SUITE 500, 3000 K STREET NW, WASHINGTON, DC, 20007, US

(73) Assignee: KANSAI PAINT CO., LTD.

(21) Appl. No.: 10/843,667

(22) Filed: May 12, 2004

(30) Foreign Application Priority Data
May 14, 2003 (JP) P.2003-136369

(51) Int. Cl. H01Q 1/32

(52) U.S. Cl. 343/713

(57) ABSTRACT

The present invention provides a method for forming an automotive antenna, comprising: forming an antenna circuit film made from a conductive paste on an electrodeposition coating film or intermediate coating film formed on an outside plate member of a car body; and then forming a single-layer or multi-layered coating film on the antenna circuit film. Also disclosed is a car having provided the automotive antenna.

### FIELD OF THE INVENTION

The present invention relates to an automotive antenna forming method and also a car having an antenna film in a coating film of an outside plate member thereof.

### BACKGROUND OF THE INVENTION

Conventionally, automotive antennas have a major role to receive a radio wave of a radio. Recently, however, automotive antennas have a variety of roles, e.g., for receiving a radio wave of a television, for GPS (global positioning system), keyless entry system, for ETC (electronic toll collection) system, etc., so that various antennas are fitted to the car.

As the automotive antenna, a rod antenna fitted to the outside of a car is common. Since the rod antenna is used to project from the car, there have been problems such that the antenna can be a hindrance upon driving, cleaning, etc. and the antenna can be readily broken.

Therefore, a method of fitting an antenna to a window glass has come into common use, and there have bee developed a method of putting an antenna between two sheets of glass and a method of laminating a film-form antenna onto a glass. Also, an antenna is often installed into the interior of a car. In this case, the antenna is installed into an inside of a roof panel, a back surface of a room mirror, etc. so as not to be hindrance (see, for example, Patent Documents 1-3, etc.).

However, according to the method of fitting an antenna to a glass, there exists such a problem that transparency of the glass becomes lowered. Also, since the material of the antenna considerably deteriorates the strength of a regenerated glass upon recycling the glass, such material of the antenna is hindrance to the recycling. In the interior of the car, on the other hand, a measure is taken to reduce troubles caused by unnecessary incoming radio waves as much as possible. Therefore, with the antenna installed into the interior of the car, there exists such a problem that it is difficult for the antenna to exhibit its effect satisfactorily.

As the method of fitting an antenna to an outside portion of a car body so as not to be hindrance, a method of forming a groove on an outside portion of the car body and then embedding the antenna in the groove is disclosed (see Patent Document 4). However, according to this method, the groove must be formed on the car body. Thus, the car production line must be reconstructed correspondingly and also production efficiency becomes lowered.

Patent Document 1: JP 08-242114 A

Patent Document 2: JP 05-291809 A

Patent Document 3: JP 10-041719 A

Patent Document 4: JP 06-152489 A

### SUMMARY OF THE INVENTION

It is an object of the present invention to provide a method of forming an automotive antenna that can be formed easily on an outside plate member of a car without obstacle and is excellent in durability.

Another object of the present invention is to provide a car having an antenna circuit film formed in accordance with the automotive antenna forming method.

Other objects and effects of the present invention will become more apparent from the following description.

As the result of the extensive studies made by the inventors to achieve the above-described objects, the inventors found the fact that an effect of an antenna can be exerted satisfactorily by forming an antenna film on a metal plate constituting a car body via an electrodeposition coating film or intermediate coating film serving as the dielectric substance and that an antenna which is not obstructive and is excellent in weather resistance can be formed by forming further a film such as an overcoat or the like on the antenna film. The present invention is based on these findings.

The present invention relates to a method for forming an automotive antenna, comprising:

forming an antenna circuit film made from a conductive paste on an electrodeposition coating film or intermediate coating film formed on an outside plate member of a car body; and then

forming a single-layer or multi-layered coating film on the antenna circuit film.

The present invention also relates to a car having, in a coating film of an outside plate member of its body, an antenna circuit film formed in accordance with the above-described automotive antenna forming method.

### DETAILED DESCRIPTION OF THE INVENTION

The present invention provides an automotive antenna forming method comprising forming an antenna circuit film on an electrodeposition coating film or intermediate coating film of an outside plate member of a car body, and then forming a single-layer or multi-layered coating film on the antenna circuit film.

Location for Antenna Formation

In the case that an antenna film is formed directly on a metal material constituting a car body, it is difficult to cause such film to act as an antenna. Therefore, the antenna film must be formed via an electrodeposition coating film or an intermediate coating film.

The antenna can be formed on an outside plate member of the car, e.g., roof, bonnet, fender, door, trunk, etc., without any particular restriction imposed on the location. It is particularly preferred that the antenna is formed on a roof where the radio wave is easily received and the damage is hard to occur.

Forming Method of Antenna Circuit

The antenna circuit can be formed by coating a conductive paste by means of a spray, a roller, a brush, etc. or printing the conductive paste by means of a silk screen printing, etc. directly on the electrodeposition coating film or intermediate coating film formed on the outside plate member of the car body. Alternatively, the antenna circuit can be formed by transferring an antenna circuit, which has been drawn beforehand on a film using the conductive paste, onto the electrodeposition coating film or the intermediate coating film (film transfer method). In addition, the antenna circuit can be formed by laminating a film-form antenna as it is onto the electrodeposition coating film or the intermediate coating film. Other methods can be of course employed. At this time, a dielectric material film may be further formed on the electrodeposition coating film or the intermediate coating film prior to the formation of the antenna circuit so as to increase the sensitivity. The dielectric material film may be formed by any method such as coating, printing, transferring, etc., and any method convenient for manufacturing steps can be selected.

The conductive paste can be obtained by dispersing conductive powder (B) into a thermosetting or thermoplastic resin (A). Herein, the viscosity of the paste is adjusted by an organic solvent (C) and/or water.

The thermosetting or thermoplastic resin (A) may be any without any particular restriction so long as the resin is commonly used in a car paint. Thermosetting resins are preferred from an aspect of physical properties of the coating film. As for the kind of the resin, there can be cited, for example, acrylic resins, polyester resins, polyurethane resins, epoxy resins. If the resin has a hydroxyl group, it can be suitably employed by using a curing agent such as a melamine resin and a polyisocyanate compound (the isocyanate may be blocked) in combination. Also, if the resin has a carboxyl group, it can be suitably employed by using a curing agent such as epoxy group-containing resin in combination. As for the above-described resins, although those being dissolved in an organic solvent can be suitably employed, they may be capable of being dissolved or dispersed into water.

The conductive powders (B) include, for example, fine powder of any of silver, nickel, copper, electrolytic copper, conductive carbon, indium oxide, tin-doped indium oxide, conductive tin oxide, conductive zinc oxide, and conductively processed mica. In particular, powder of the conductive metal such as silver, nickel, copper, electrolytic copper, etc. can be preferably employed. Also, copper powder that is plated with silver can be employed. Also, flattened conductive powder is preferred to improve the conductivity. The average primary particle size of the conductive powder (B) used in the present invention is preferably from 0.1 μm to 30 μm, particularly preferably from about 0.5 μm to about 20 μm. The conductivity is lowered if the particle size is excessively small, while an appearance of the coating film is deteriorated if the particle size is excessively large.

The optimum addition amount of the conductive powder (B) varies depending on the kind, particle size, shape, etc. of the metal. It is preferred that the amount of the powder is decided so as to give a specific volume resistivity of the film formed by the conductive paste of 10⁶ Ω·cm or less, particularly preferably 10³ Ω·cm or less. Also, it is preferred from the aspects of the conductivity and physical properties of the coating film that the amount of the conductive powder (B) is within the range of 10 to 400 parts by weight, particularly preferably about 50 to 300 parts by weight, per 100 parts by weight of the solid content of the thermosetting or thermoplastic resin (A).

The conductive paste can be obtained by adding the resin (A), and optionally the organic solvent (C), to the conductive powder (B) and then dispersing the resultant by means of a dispersing device such as a sand mill.

Any solvent may be employed as the organic solvent (C) without any particular restriction so long as the solvent can dissolve the resin (A). The organic solvent include, for example, hydrocarbon solvents such as toluene, xylene and high boiling petroleum based hydrocarbons, ketone solvents such as methyl ethyl ketone, methyl isobutyl ketone, cyclohexanone and isophorone, ester solvents such as ethyl acetate, butyl acetate, ethylene glycol monoethyl ether acetate and diethylene glycol monoethyl ether acetate, alcohol solvents such as methanol, ethanol and butanol, ether alcohol solvents such as ethylene glycol monoethyl ether, ethylene glycol monobutyl ether and diethylene glycol monobutyl ether. These solvents can be used singly or as a mixture of two or more thereof.

From the aspect of handling property, the amount of the organic solvent (C) used is preferably from 10 to 1000 parts by weight, particularly preferably from 50 to 500 parts by weight, per 100 parts by weight of the solid content of the thermosetting or thermoplastic resin (A).

As needed, the conductive paste may further comprise conventionally known pigments and additives for paint, such as pigments (e.g., coloring pigment, extender, etc.), and additives such as pigment dispersant, aggregation inhibitor, sedimentation inhibitor, lubricant, leveling agent, antifoaming agent, ultraviolet absorbent, etc.

In the present invention, the antenna circuit film is formed on the electrodeposition coating film or the intermediate coating film by, for example, coating, printing or film-transferring the conductive paste, or by laminating the film-form antenna. Herein, it is preferred that the dried film thickness of the antenna circuit film is within the range of from 1 to 50 μm, particularly preferably 5 to 30 μm. If the film thickness is too thin, the conductivity of the film is lowered and the film fails to carry out the function of the antenna. In contrast, if the film thickness is too thick, the shape of the antenna circuit becomes conspicuous even when the overcoat is formed thereon.

As described above, the antenna circuit is formed on the electrodeposition coating film or the intermediate coating film of the outside plate member of the car body, then an intermediate coating film is optionally formed thereon as needed, and then the overcoat is formed thereon. The (second) intermediate coating film and the overcoat may be any without any particular restriction so long as they are commonly used for a car. The overcoat may have either a single layer structure or a multi-layered structure. If the conductive paste employed to form the antenna circuit is thermosetting, the conductive paste may be heated to cure immediately after the formation of the antenna circuit. Alternatively, the conductive paste may be cured at the same time when the intermediate coating paint or the overcoat paint coated thereon is heated to cure.

Only one antenna circuit may be formed, or a plurality of antenna circuits may be formed. It is preferred that the shape of the antenna circuit, the film thickness, the location of the antenna circuit, etc. are appropriately selected in accordance with the application.

The application of the antenna forming method of the present invention is not limited to car, and the present invention may also apply to other vehicles and articles so long as the concept of the invention can apply thereto.

Further details and preferred embodiments of the above-mentioned electrodeposition coating film, intermediate coating film, dielectric material film and overcoat are described below.

1) Electrodeposition Coating Film:

The electrodeposition paint may be either anion type or cation type. In general, the cation type paint is preferred from the aspect of corrosion resistance. As the base resin of the electrodeposition paint, any of epoxy resin, acrylic resin, polybutadiene resin, alkyd resin, polyester resin, etc. may be employed. Among them, polyamine resins represented, for example, by amine-added epoxy resin are preferred. As the curing agent, there can be used known curing agents such as blocked polyisocyanate compounds, amino resins, etc. In particular, blocked polyisocyanate compounds are preferred.

The cationic electrodeposition coating can be usually carried out under the conditions of a bath temperature adjusted to 15 to 35° C. and an applied voltage set to 100 to 400 V. The film thickness of the electrodeposition coating film is not particularly limited. In general, it is preferably within the range of 10 to 40 μm in terms of the cured coating film thickness. In general, it is suitable that the baking curing temperature of the coating film is within the range of 100 to 200° C. and the baking curing time is for 5 to 90 minutes.

2) Intermediate Coating Film:

Although the formation of the antenna circuit and the coating of the overcoat paint may be directly performed onto the electrodeposition coating film, the intermediate coating paint can be coated between the electrodeposition coating film and the antenna circuit or between the antenna circuit and the overcoat to improve smoothness, sharpness, interlayer adhesion, chipping resistance, etc. Known paints can be used as the intermediate coating paint. For example, there can be used organic solvent based intermediate coating paints and aqueous intermediate coating paints, comprising a base resin such as acrylic resin, polyester resin, alkyd resin, etc., a curing agent such as melamine resin, (blocked) polyisocyanate compound, etc., a coloring pigment, an extender, etc. The intermediate coating paint may be coated on the overall front and back surfaces of the car body. Alternatively, it may be coated only onto the necessary portion, e.g., the outside plate member of the car. The coating can be carried out by air spray coating, airless spray coating, electrostatic coating, etc. The film thickness of the intermediate coating film is preferably within the range of 10 to 40 μm in terms of the cured coating film thickness. The coating film can be cured by heating, generally, at 100 to 170° C. for 10 to 40 minutes.

3) Dielectric Material Film:

For the formation of the dielectric material film, a coating composition formed by dispersing high-dielectric powder into a thermosetting or thermoplastic resin can be suitably employed. As the thermosetting or thermoplastic resin, resins referred to in the description of the conductive paste can be employed, and examples thereof include acrylic resins, polyester resins, polyurethane resins, epoxy resins, etc. If the resin has a hydroxyl group, it can be suitably employed by using a curing agent such as a melamine resin and a polyisocyanate compound (the isocyanate may be blocked) in combination. Also, if the resin has a carboxyl group, it can be suitably employed by using a curing agent such as epoxy group-containing resin in combination. As for the above-described resins, although those being dissolved in an organic solvent can be suitably employed, they may be capable of being dissolved or dispersed into water.

Preferred high-dielectric material includes, for example, titanate compound such as barium titanate, strontium titanate, zirconium titanate, potassium titanate, etc.; silicon carbide; silicon nitride.

The high-dielectric material preferably has a granular or whisker shape. Although the particle size or the whisker length is not particularly restricted, they are preferably 100 μm or less from the aspect of dispersibility, etc. The film thickness of the dielectric material film is preferably within the range of 1 to 50 μm, particularly preferably 5 to 30 μm, in terms of dried film thickness.

4) Overcoat:

The formation of the overcoat can be carried out, for example, by using a solid color paint or a metallic paint as the over coating paint and optionally using a clear paint in combination as needed, with a 1-coat/1-bake system, a 2-coat/1-bake system, a 2-coat/2-bake system, etc.

The solid color paint is a thermosetting paint containing, as a coloring pigment, a solid color pigment such as an inorganic or organic pigment including, for example, titanium oxide, zinc white, carbon black, cadmium red, molybdenum red, chrome yellow, chromium oxide, Prussian blue, cobalt blue, azo pigment, phthalocyanine pigment, quinacridone pigment, isoindoline pigment, threne pigment, perylene pigment. The metallic paint is a thermosetting paint containing a metallic pigment such as scaly aluminum, mica, mica surface-coated with a metal oxide, micaceous-form iron oxide. These paints are preferably those having excellent background-hiding property.

The solid color paint is a thermosetting paint containing a thermosetting resin component and a solid color pigment. Examples thereof include, for example, compositions comprising as the thermosetting resin component: a base resin such as acrylic resin having a crosslinking functional group (e.g., hydroxyl group), polyester resin and urethane resin; and a crosslinking agent such as melamine resin, polyisocyanate compound and blocked polyisocyanate compound. The metallic paint is a thermosetting paint containing a thermosetting resin component and a metallic pigment. Examples thereof include, for example, compositions comprising as the thermosetting resin component: a base resin such as acrylic resin having a crosslinking functional group (e.g., hydroxyl group), polyester resin and urethane resin; and a crosslinking agent such as melamine resin, polyisocyanate compound and blocked polyisocyanate compound.

Also, the clear paint is a paint that mainly comprises a thermosetting resin component and forms a colorless transparent or colored transparent coating film. Examples thereof include compositions comprising as the resin component: a base resin such as acrylic resin having a crosslinking functional group (e.g., hydroxyl group), polyester resin and urethane resin; and a crosslinking agent such as melamine resin, polyisocyanate compound and blocked polyisocyanate compound.

The solid color paint or the metallic paint is generally adjusted to have a solid content concentration of about 20 to 60 wt % and a viscosity of about 10 to 40 second (Ford cup #4/20° C.). Then, the solid color paint or the metallic paint can be coated on the antenna circuit film, or the dielectric material film optionally formed on the antenna circuit, or the intermediate coating film by a method such as air spray coating, airless spray coating, electrostatic coating, etc. so as to give a film thickness (in terms of cured coating film thickness) of about 20 to 60 μm in the case of the solid color paint and of about 5 to 30 μm in the case of the metallic paint. The coating film can be cured by heating at a temperature of about 120 to 160° C. for about 10 to 40 minutes. Further, either after these coating films are cured or in the state where these coating films are not cured yet, the clear paint adjusted to have a solid content concentration of about 20 to 60 wt % and a viscosity of about 10 to 40 second (Ford cup #4/20° C.) can be coated by a method such as air spray coating, airless spray coating, electrostatic coating, etc. so as to give a film thickness (in terms of cured coating film thickness) of about 20 to 60 μm, and then cured by heating at a temperature of about 120 to 160° C. for about 10 to 40 minutes.

### EXAMPLES

The present invention will be illustrated in greater detail with reference to the following Examples and Comparative Examples, but the invention should not be construed as being limited thereto. All the “parts” and “%” are given by weight unless otherwise indicated.

### Synthesis Example 1 (Acrylic Resin)

Xylene (100 parts) was put into a common acrylic resin-manufacturing apparatus equipped with a heating unit, a stirrer, a refluxing unit, a thermometer, etc. Then, the xylene was stirred at 125° C. while blowing a nitrogen gas into the apparatus, and a mixture that consists of 20 parts of styrene, 20 parts of i-butyl methacrylate, 20 parts of methyl methacrylate, 21.7 parts of 2-ethyl hexylacrylater, 0.5 part of acrylic acid, 17.8 parts of 2-hydroxy ethylacrylate, and 3.3 pars of 2,2′-azobisisobutyronitrile was dropped therein at a uniform rate over a period of three hours. The resultant mixture was matured at the same temperature for two hours, to thereby obtain an acrylic resin solution (A) having a solid content of 50%. The weight-average molecular weight of the resultant acrylic resin was 11,000.

### Synthesis Example 2 (Polyester Resin)

Isophthalic acid (0.29 mol), 0.23 mol of phthalic acid, 0.43 mol of hexahydrophthalic acid, 0.4 mol of trimethylolpropane, 0.6 mol of neopentyl glycol, and 0.1 mol of coconut oil fatty acid were put into a common polyester resin-manufacturing apparatus equipped with a heating unit, a stirrer, a refluxing unit, a water separator, a rectification column, a thermometer, etc. and then heated. Then, the stirring was started after the materials were melted to permit such stirring, and the temperature of the reaction tank was raised up to 230° C. Herein, the temperature raise from 160° C. to 230° C. was carried out at a uniform rate over a period of three hours. The condensed water generated was removed to the outside of the system via the rectification column. The temperature was kept constant after the temperature reached 230° C., and the stirring was continued for two hours. Thereafter, xylol was added into the reaction tank, and then the reaction was continued by switching into the solvent condensation method. The reaction was stopped when the acid value reached 8 mgKOH/g, and it followed by cooling. When the temperature was cooled down to 140° C., the resultant solution was diluted by adding xylol thereto. As a result, a coconut oil modified polyester resin (B) having a solid content concentration of 60% was obtained. The hydroxyl value of the resultant resin was 72 mgKOH/g.

### Example 1

Metal nickel powder (100 parts) having an average particle diameter of 5 μm was added to 100 parts of the acrylic resin solution (A) having a solid content of 50%, and then grinding by paint shaker was carried out for 60 minutes. Thereafter, 10 parts of amidation castor oil precipitation inhibitor (DISPARLON, product name, manufactured by Kusumoto Chemicals, Ltd.) was added thereto, and then grinding by paint shaker was carried out for 20 minutes to make the resultant mixture uniform. Then, added thereto were 25 parts of “U-VAN 28-60” (product name, butyl etherification melamine resin manufactured by Mitsui Chemicals Inc., solid content 60%) and further a mixed solvent of xylene/butanol (50/50) for adjusting the coating viscosity, to thereby obtain a conductive paste. The conductive paste was coated on a glass plate by air spray coating so as to give a dried film thickness of 30 μm. Then, the coating film was cured by heating at an atmosphere temperature of 140° C. for 20 minutes by means of a hot-air drying furnace. The specific volume resistivity of the film measured after cooling was 4.3×10⁻³ Ω·cm.

A thermosetting epoxy resin based cationic electrodeposition paint “ELECRON 9600” (product name, manufactured by Kansai Paint Co., Ltd.) was coated on a dull steel sheet of 0.8 mm thickness, which had been subjected to zinc phosphate chemical treatment, by electrodeposition so as to give a cured film thickness of about 20 μm, and then the coating was heated and cured at 170° C. for 30 minutes. Thereafter, a car intermediate coating paint “TP-65 PRIMER-SURFACER” (product name, thermosetting polyester resin/melamine resin based organic solvent type paint, manufactured by Kansai Paint Co., Ltd.) was coated thereon by air spray coating so as to give a cured film thickness of about 25 μm, and then the coating was heated and cured at 140° C. for 30 minutes. Thus, a test substance to be coated was prepared. Then, an antenna film was formed by coating the above-described conductive paste on the test substance by air spray coating through a pattern paper of a linear antenna shape (for the personal radio) so as to give a dried film thickness of 30 μm, and then heating the coated conductive paste to cure at 140° C. for 20 minutes. After wiring the antenna film to a receiving part, an overcoat paint “NEO AMILAC 300” (product name, hydroxyl group-containing polyester resin/melamine resin based solid color organic solvent type paint, manufactured by Kansai Paint Co., Ltd., white color) was coated on the coated board having the antenna film thereon by air spray coating so as to give a cured film thickness of about 30 μm, followed by heating it to cure at 140° C. for 30 minutes. The resultant antenna film in the coating films was able to receive the radio wave of the personal radio satisfactorily.

### Example 2

Electrolytic copper powder (100 parts) having an average particle diameter of 2 μm was added to 83 parts of the coconut oil modified polyester resin (B) having a solid content of 60%, then grinding by paint shaker was carried out for 60 minutes. Thereafter, 10 parts of amidation castor oil precipitation inhibitor (DISPARLON, product name, manufactured by Kusumoto Chemicals, Ltd.) was added thereto, and then grinding by paint shaker was carried out for 20 minutes to make the resultant mixture uniform. Then, added thereto were 25 parts of “U-VAN 28-60” (product name, butyl etherification melamine resin, manufactured by Mitsui Chemicals Inc., solid content 60%) and further a mixed solvent of xylene/butanol/butyl acetate (40/40/20) for adjusting the coating viscosity, to thereby obtain a conductive paste. The conductive paste was printed on a glass plate by silk screen printing so as to give a dried film thickness of 25 μm. Then, the coating film was cured by heating at an atmosphere temperature of 140° C. for 20 minutes by means of a hot-air drying furnace. The specific volume resistivity of the film measured after cooling was 2.5×10⁻³ Ω·cm.

A thermosetting epoxy resin based cationic electrodeposition paint “ELECRON 9600” (product name, manufactured by Kansai Paint Co., Ltd.) was coated on a dull steel sheet of 0.8 mm thickness, which had been subjected to zinc phosphate chemical treatment, by electrodeposition so as to give a cured film thickness of about 20 μm, and then the coating was heated and cured at 170° C. for 30 minutes. Thereafter, an antenna film was formed by printing the above-described conductive paste on the electrodeposition coating film by silk screen printing to form a linear antenna shape (for the personal radio) having a dried film thickness of 25 μm, and then heating and curing the coated conductive paste at 140° C. for 20 minutes. After wiring the antenna film to a receiving part, a car intermediate coating paint “TP-65 PRIMER-SURFACER” (product name, thermosetting polyester resin/melamine resin based organic solvent type paint, manufactured by Kansai Paint Co., Ltd.) was coated on the coated board having the antenna film printed thereon, by air spray coating so as to give a cured film thickness of about 25 μm. Then, the coating film was cured by heating at 140° C. for 30 minutes. Thereafter, a car overcoat base paint “MAGICRON SILVER METALLIC” (product name, acrylic resin/melamine resin based metallic paint, manufactured by Kansai Paint Co., Ltd.) of 15 μm thickness (in terms of cured coating film thickness) and a car overcoat clear paint “MAGICRON CLEAR” (product name, acrylic resin/melamine resin based paint, manufactured by Kansai Paint Co., Ltd.) of 35 μm thickness (in terms of cured coating film thickness) were coated on this intermediate coating film in a wet-on-wet manner, and then both coating films were cured simultaneously by heating at 140° C. for 30 minutes. The resultant antenna film in the coating films was able to receive the radio wave of the personal radio satisfactorily.

According to the method of the present invention, such an advantage can be achieved that since no restriction is imposed on the antenna installation location, the antenna can be formed easily by coating, etc. in conformity to the profile on the location, such as a roof portion, where the antenna does not disturb the view and the appearance design and is seldom damaged and is convenient for the reception of the radio wave. Furthermore, another advantage can be achieved that since the antenna is protected by the overcoat not to receive the deterioration caused by the external environment, the antenna is excellent in durability.

While the present invention has been described in detail and with reference to specific embodiments thereof, it will be apparent to one skilled in the art that various changes and modifications can be made therein without departing from the spirit and scope thereof.

The present application is based on Japanese patent application No. 2003-136369 filed May 14, 2004, the contents thereof being herein incorporated by reference.

What is claimed is:

1. A method for forming an automotive antenna, comprising:
forming an antenna circuit film made from a conductive paste on an electrodeposition coating film or intermediate coating film formed on an outside plate member of a car body; and then
forming a single-layer or multi-layered coating film on the antenna circuit film.

2. The automotive antenna forming method according to claim 1, wherein said formation of the antenna circuit film is carried out by coating a conductive paste on the electrodeposition or intermediate coating film.

3. The automotive antenna forming method according to claim 1, wherein said formation of the antenna circuit film is carried out by printing a conductive paste on the electrodeposition or intermediate coating film.

4. The automotive antenna forming method according to claim 1, wherein said formation of the antenna circuit film is carried out by transferring an antenna circuit film that is made from a conductive paste and formed on a film, onto the electrodeposition or intermediate coating film.

5. The automotive antenna forming method according to claim 1, wherein said formation of the antenna circuit film is carried out by laminating a film antenna onto the electrodeposition or intermediate coating film.

6. The automotive antenna forming method according to claim 1, wherein said conductive paste comprises (A) a thermosetting or thermoplastic resin and (B) a conductive powder.

7. The automotive antenna forming method according to claim 6, wherein said conductive paste further comprises (C) an organic solvent.

8. The automotive antenna forming method according to claim 6, wherein said circuit film made from the conductive paste has a specific volume resistivity of 10⁶ Ω·cm or less.

9. The automotive antenna forming method according to claim 6, wherein said conductive powder (B) comprises powder of at least one metal selected from the group consisting of silver, copper, electrolytic copper, and nickel.

10. The automotive antenna forming method according to claim 6, wherein said conductive paste contains said conductive powder (B) in an amount of 10 to 400 parts by weight per 100 parts by weight of the solid content of said thermosetting or thermoplastic resin (A).

11. The automotive antenna forming method according to claim 1, wherein said antenna is formed on a roof of the outside plate member of the car body.

12. The automotive antenna forming method according to claim 1, wherein said antenna circuit film has a dried film thickness within the range of 1 to 50 μm.

13. The automotive antenna forming method according to claim 1, further comprising a step of forming a dielectric material film onto said electrodeposition or intermediate coating film, prior to said formation of the antenna circuit film.

14. A car having, in a coating film of an outside plate member of its body, an antenna circuit film formed in accordance with the automotive antenna forming method according to claim 1.
